(19) United States
(12) Patent Application Publication
(10) Pub. No.: US 2012/0272482 A1
(43) Pub. Date: Nov. 1, 2012

(54) DOOR STOPPER

(76) Inventor: Alan Evans, Oakesdale, WA (US)

(21) Appl. No.: 13/097,539

(22) Filed: Apr. 29, 2011

(51) Int. Cl. E05F 5/06; E05F 5/00

(52) U.S. Cl. 16/86 R; 16/82

(57) ABSTRACT

A door stop may prevent a complete closure of a door. According to some implementations, the door stop may be positioned on a side rail and/or a top rail of a door to prevent the door from completely closing. The door stop may be adjusted along the side rail and/or top rail until a desired opening/closure of the door is achieved. Furthermore, the door stop may be removed and repositioned until a new desired opening/closure of the door is achieved. While the door stop is in position, the door remains free for use by a user.

### BACKGROUND

Door stopping devices are used to hold a door fully open, partially open, or completely closed. There are a number of door stops available in today's market, incorporating various designs.

One example design of a conventional door stop includes a wedge-like design. The wedge-like door stop generally functions by placing the door stop parallel to the floor or the wall. For example, the wedge-like door stop is generally placed on the floor under the door, propping the door open. The door is set in a specific fixed position, preventing the adjustment of the position of the door without first removing the wedge-like door stop, and further preventing normal use of the door (i.e., exiting or entering a room in a house). Furthermore, when the wedge-like door stop is not in use, the consumer is likely to leave the door stop on the floor, resulting in a potential safety hazard.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Some implementations herein include a door stop to be placed along a rail of a door such that the position of the door may be adjusted to a desired opening/closing of the door. To facilitate an adjustment, the door stop is placed on a rail of the door such that a first side of the door stop grips a first panel of the door and a second side of the door stop grips a second panel of the door.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical items.

FIG. 1 is a front side view of an illustrative door stop.

FIG. 2 is a front side view of an alternative door stop.

FIG. 3 is a perspective view of the illustrative door stop of FIG. 1.

FIG. 4 is a schematic of an illustrative single door environment for use with the door stop of FIG. 1 and/or FIG. 2.

FIG. 5 is a schematic of a double door environment for use with the door stop of FIG. 1 and/or FIG. 2.

FIG. 6 is a schematic of a sliding door environment for use with the door stop of FIG. 1 and/or FIG. 2.

FIG. 7 is a detailed schematic of the illustrative single door environment of FIG. 4.

FIG. 8 is a detailed schematic of the illustrative double door environment of FIG. 5.

FIG. 9 is a flow diagram of an example process to use the door stop of FIG. 1 and/or FIG. 2.

### DETAILED DESCRIPTION

Some implementations herein provide a device for preventing a complete closure of a door. Specifically, the device may be positioned on a top portion or a side portion of a door to prevent the door from completely closing. While the door stop is in position, the door remains free for use by a user, i.e., the door may be freely opened and used for entry and/or exit without obstruction from the door stop. While the detailed description which follows refers to a device for use with a door, it is to be appreciated by one skilled in the art that the device may be used in other environments as well, for example, a window.

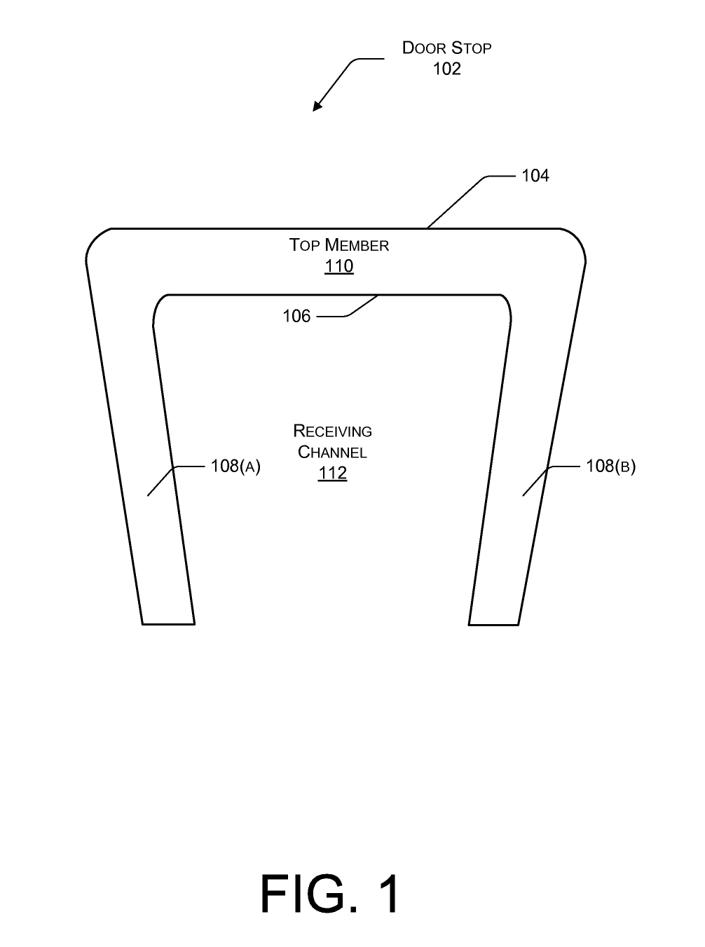

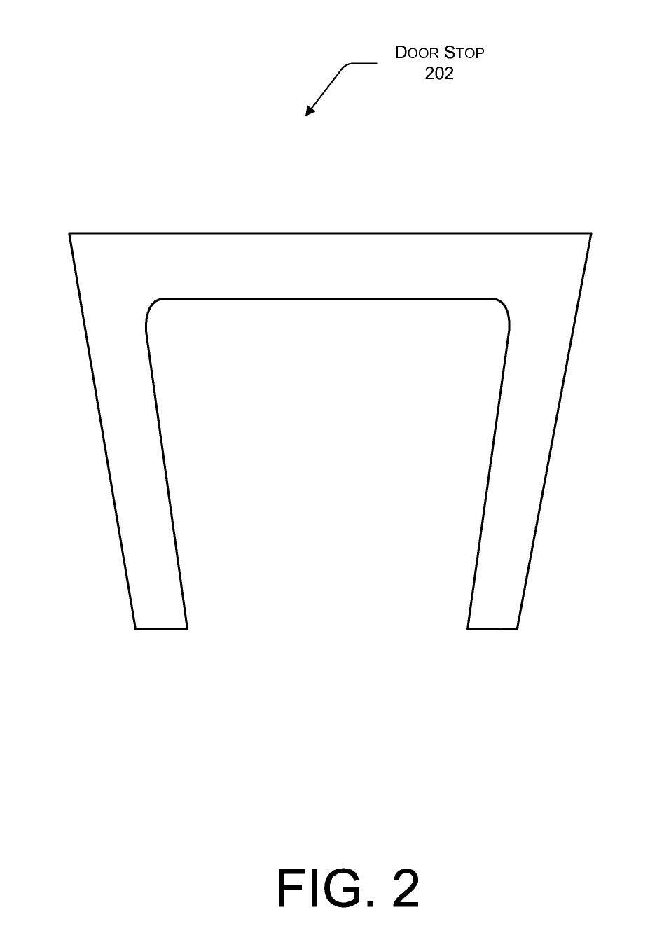

FIG. 1 illustrates a front side view of a door stop 102. The door stop 102 includes, in one implementation, a top portion 104, a bottom portion 106, and a side portion 108(a) and a side portion 108(b). The bottom portion 106 lies underneath the top portion 104, creating a top member 110. A receiving channel 112 lies intermediate to the top member 110 and the side portions 108(a) and 108(b), creating a “U” shape design. Alternatively, the door stop 102 may be designed using any suitable shape. For example, FIG. 2 illustrates an alternative door stop 202.

The “U” shape design discussed above with respect to FIG. 1 enables the door stop 102 to be positioned on a top rail or side rail of an interior or an exterior door. The door stop 102 is designed for use with a standard interior door where the top rail typically measures between 1⅜ inches and 1¾ inches and a standard exterior door where the top rail typically measures 1¾ inches. Alternatively, the door stop 102 may be designed to fit a custom designed interior or exterior door, where the top rail is any desired measurement.

In one implementation, the door stop 102 is installed by sliding the door stop on the top rail and/or the side rail of the door such that the top rail and/or side rail is positioned within the receiving channel 112. Alternatively, the door stop 102 may be pressed or pushed onto the door such that the top rail or the side rail is inserted into the receiving channel 112 of the door stop 102. Once the door stop 102 has been placed on the door, the door stop may be adjusted along the top rail and/or the side rail enabling the user to position the door in a desired open/closed position, for example, 25% closed. Furthermore, the door stop 102 may be mounted on the door using mounting materials such as, for instance, screws and/or nails.

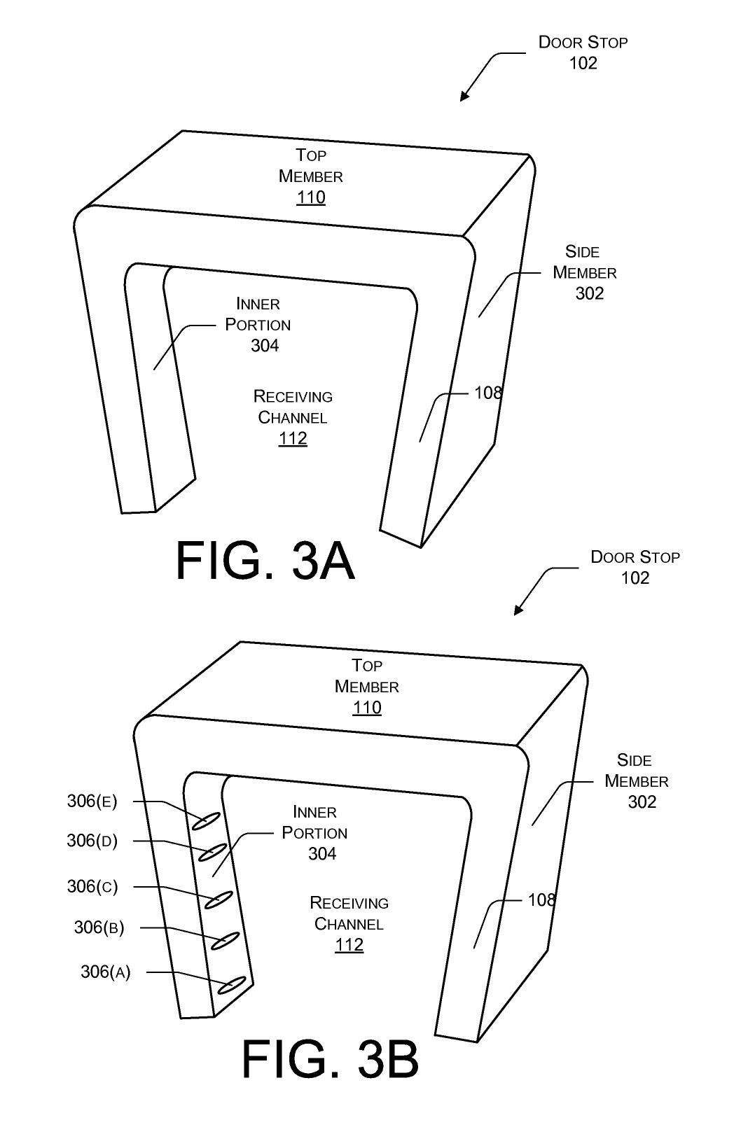

FIG. 3A illustrates a perspective view of the door stop 102. As shown in FIG. 3A, the receiving channel 112 is further defined by a side member 302. The side member 302 grips a panel of the door when placed on the top rail or the side rail for a secure placement, ensuring that the door stop 102 does not deviate from the desired location on the door. In one implementation, the side member 302 includes an inner surface 304. As illustrated in FIG. 3B, the inner surface 304 may include one or more protruding components 306(a)-306(n) to enhance the grip on the panel of the door. Alternatively, the inner surface 304 may have a smooth surface.

In one implementation, the door stop 102 is manufactured from a non-marring and flexible compound, for example, a rubber or plastic compound. Alternatively, the door stop 102 may be manufactured out of any suitable material. The door stop 102 is manufactured in a variety of colors, enabling the user to purchase any desired color. For example, without limitation, black, white, blue, red, green, or any suitable color.

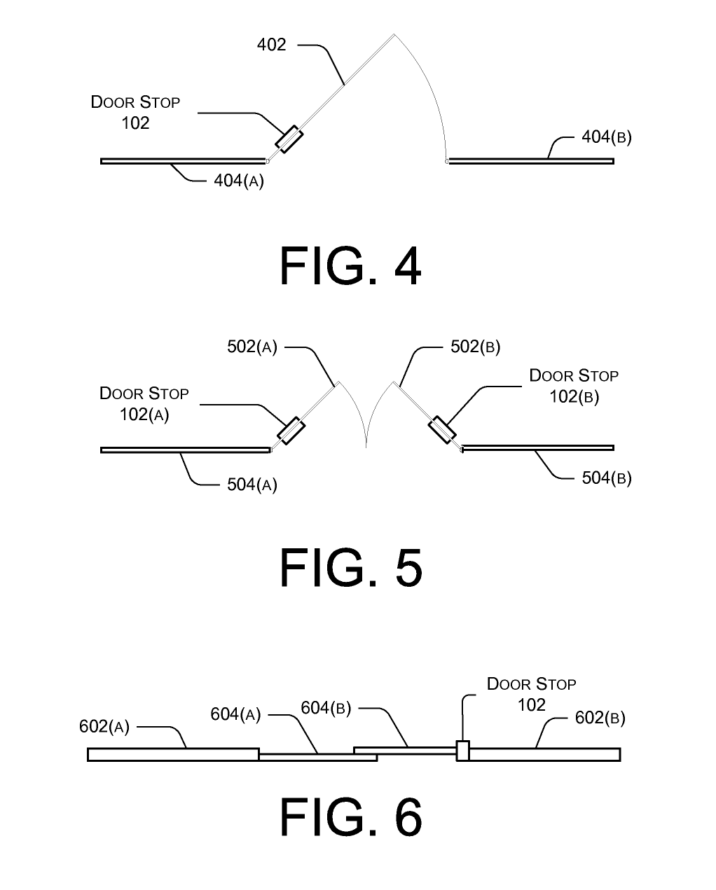

FIG. 4 illustrates the placement of the door stop 102 on a single door 402. The single door 402 is situated on a wall 404(a) and 404(b). The door stop 102 may be placed anywhere along the top rail of the single door 402, permitting the single door 402 to be wide open, partially open, or almost closed. For example, the placement of the door stop 102 may permit the single door 402 to be positioned between about a 90 degree position, fully open, to about 1 degree position, almost closed. For example, FIG. 3 illustrates the placement of the door stop 102 resulting in a position of the single door 402 to be about twenty five percent open (or 75 percent closed).

FIG. 5 illustrates the placement of the door stop 102 within a double door system including a first door 502(a) and a second door 502(b). The first door 502(a) is situated along a wall 504(a), and the second door 502(b) situated along a wall 504(b). As shown in FIG. 5, a single door stop 102(a) may be used with one door, for example, the first door 502(a), and a second door stop 102(b) may also be used with the second door 502(b).

FIG. 6 illustrates the placement of the door stop 102 within a sliding door system. The sliding door system includes a door 604(a) and a door 604(b) situated between a wall 602(a) and a wall 602(b). As illustrated, the door stop may be placed on a side rail of the door 604(b) such that the door is not able to come to a complete close. Alternatively, the door stop 102 may be placed along wall 602(b) such that when the door 604(b) is moved towards the closed position, the door stop 102 will prevent the door 604(b) from completely closing.

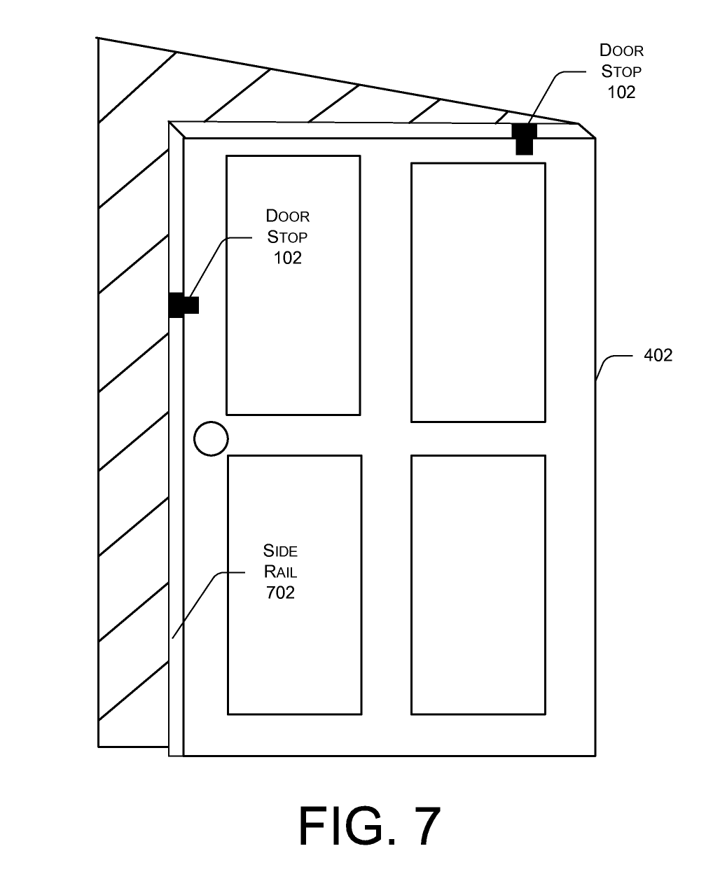

FIG. 7 further illustrates the door stop 102 in use with the single door 402. As shown in FIG. 7, the door stop 102 may be placed along the top rail of the single door 402, and/or along a side rail 702 of the single door 402.

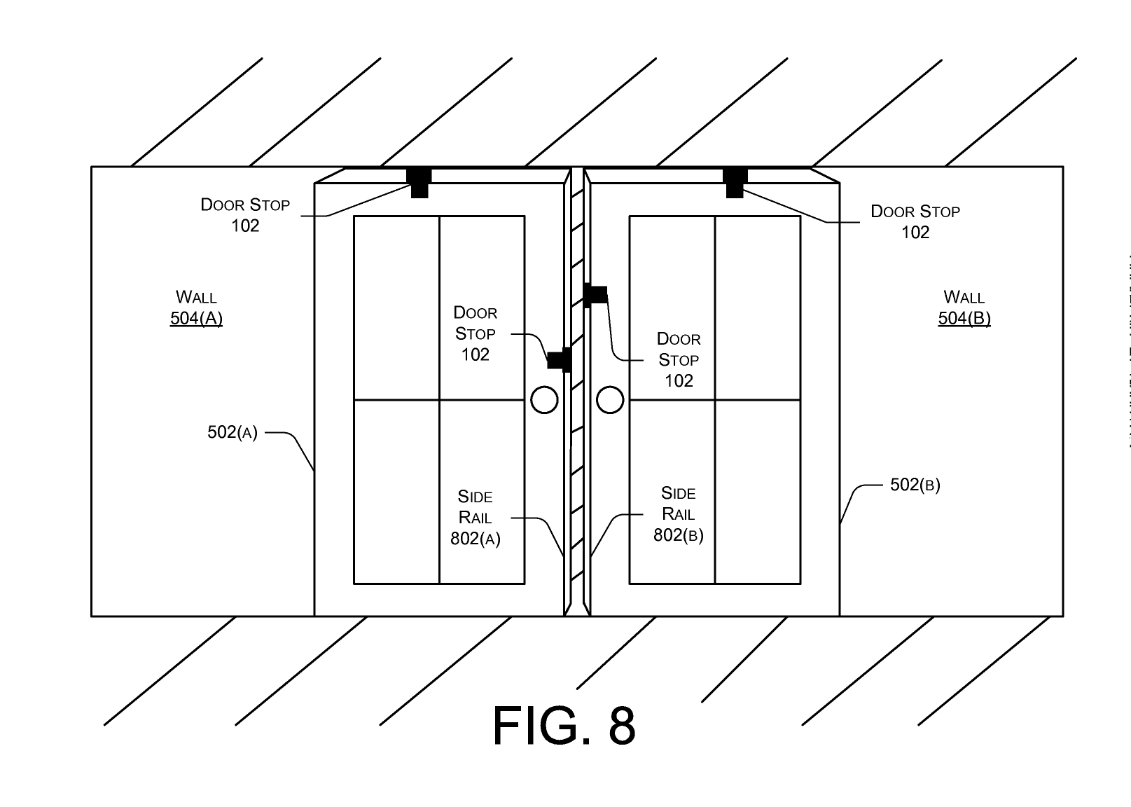

FIG. 8 further illustrates the door stop 102 in use with the double door system including the door 502(a) and 502(b). As shown in FIG. 8, the door stop 102 may be placed along the top rail of door 502(a) and/or 502(b), and/or along a side rail 802(a) and/or 802 (b) of door 502(a) and/or 502(b), respectively.

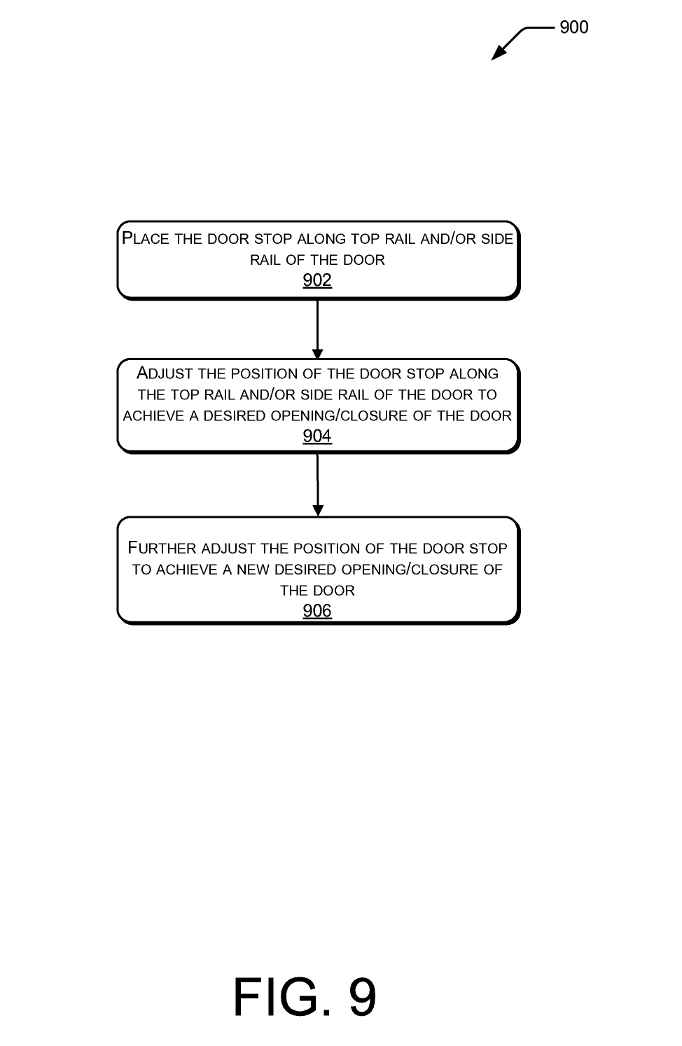

FIG. 9 illustrates a flow diagram of an example process 900 outlining the placement of a door stop. The process 900 may, but need not necessarily be implemented using the environments of FIG. 6, FIG. 7, and/or FIG. 8.

At block 902, the door stop is placed along a side rail of the door and/or a top rail of the door. At block 904, the door stop is adjusted along the side rail and/or top rail. For example, the door stop may slide across the top rail of the door until the desired opening/closure of the door is achieved. Alternatively, the door stop is removed from the door and re-positioned to a new position at the door. The door stop may be removed and repositioned until the desired opening/closure of the door is achieved. If the door stop is mounted to the door using mounting material, the mounting material may be removed and the door stop adjusted along the side and/or top rail either by sliding the door stop or removing the door stop and repositioning until the desired opening/closure of the door is achieved. The mounting material may then be re-attached to the door at the new position.

At block 906, the door stop may be further adjusted to a new position along the side and/or top rail of the door. The method for adjusting the door stop may be similar to that described above in block 904.

### Conclusion

Although a door stop has been described in language specific to structural features and/or processes, it is to be understood that the subject of the appended claims are not necessarily limited to the specific features or processes described. Rather, the specific features and methods are disclosed as example implementations.

What is claimed is:

1. A method for positioning a door stop, the method comprising:
placing the door stop on a rail of a door such that a first side of the door stop grips a first panel of the door and a second side of the door stop grips a second panel of the door;
adjusting the door stop along the rail of the door to alter a position of the door; and
placing the door in the altered position while the door stop is on the rail of the door.

2. The method of claim 1, wherein the rail of the door is a top rail or a side rail.

3. The method of claim 1, wherein:
the first side of the door stop comprises one or more protruding components; and
the second side of the door stop comprises one or more protruding components.

4. The method of claim 1, further comprising mounting the door stop to the door.

5. The method of claim 4, further comprising re-positioning the door stop by removing mounting material and adjusting the door stop to another position along the rail of the door.

6. The method of claim 1, wherein the adjusting is performed by sliding the door stop along the rail of the door.

7. The method of claim 1, wherein the adjusting is performed by:
removing the door stop from the rail of the door;
placing the door stop in another position along the rail of the door; and
pressing the door stop onto the rail of the door at the another position.

8. The method of claim 1, wherein the altered position ranges from about a 90 degree position to about a 1 degree position.

9. The method of claim 1, further comprising placing another door stop on another rail of the door such that a first side of the another door stop grips the first panel of the door and a second side of the another door stop grips the second panel of the door.

10. A door stop comprising:
a top portion;
a bottom portion lying below the top portion, the top portion and the bottom portion forming a top member;
a receiving channel lying intermediate to the top member and a side portion; and
an inner portion situated on the side portion enabling the door stop to grip the door.

11. The door stop of claim 10, wherein the rail of the door is a top rail and/or a side rail.

12. The door stop of claim 10, wherein the inner portion comprises one or more protruding components.

13. The door stop of claim 10, wherein the door is a single door, a double door, or a sliding glass door.

14. The door stop of claim 10, wherein the door stop is constructed of rubber or a plastic compound.
